(19) United States
(12) Patent Application Publication
(10) Pub. No.: US 2024/0408797 A1
(43) Pub. Date: Dec. 12, 2024

(54) Process and Machine for Releasing Curve Memory in a Reclaimed Tire Strip

(71) Applicant: Richard R. Halverson, Saginaw, TX (US)

(72) Inventor: Connor James Riland, Springfield, MO (US)

(73) Assignee: Richard R. Halverson, Saginaw, TX (US)

(21) Appl. No.: 18/680,495

(22) Filed: May 31, 2024

Related U.S. Application Data
(60) Provisional application No. 63/506,452, filed on Jun. 6, 2023.

(51) Int. Cl. B29B 17/00; B26D 3/00; B29B 17/04

(52) U.S. Cl. CPC B29B 17/0042; B26D 3/005; B29B 17/0036; B29B 17/04; B29B 2017/044

(57) ABSTRACT

A machine and process for producing a block of construction material from harvested tire tread strips by receiving a strip of flexible material having a radial curvature memory in a first direction, perforating the strip of flexible material to produce crosswise plunge cuts into the flexible material from at least a first surface, wherein each crosswise cut each extends laterally across the width of the strip of flexible material, and wherein a depth of each crosswise cut is less than the thickness of the strip of flexible material; and bending the perforated strip of flexible material in a first curvature, wherein the first curvature produces a convex shape on the first surface, wherein the bending is along a longitudinal direction of the strip of flexible material, and wherein a bending force applied to the strip is sufficient to break some of the flexible material contributing to the radial curvature memory.

### CLAIM OF BENEFIT TO FILING DATE OF EARLIER FILED PATENT APPLICATION

This Application claims benefit of the filing date of U.S. Provisional Patent Application 63/506,452, filed on Jun. 6, 2023, by Connor James Riland (Agent's docket FGP23RCX1P).

### INCORPORATION BY REFERENCE

U.S. Provisional Patent Application 63/506,452, filed on Jun. 6, 2023, by Connor James Riland (Agent's docket FGP23RCX1P), U.S. Pat. No. 6,824,070 B2, issued on Nov. 30, 2004, to Rick Halverson and Martin Diamond, and U.S. Pat. No. 10,315,391 B1, issued on Jun. 11, 2019, to Richard G. Halverson, are incorporated by reference in their entireties.

### FIELD OF THE INVENTION

The invention generally relates technologies to reclaim vehicle tires and produce blocks of material suitable for a wide range of product fabrications.

### BACKGROUND OF THE INVENTION

Many vehicles use tires made of rubber and composite resilient materials. After the useful life of the tires, the discarded tires can become an environmental hazard, so various methods have been developed to reclaim used tires for other purposes.

### SUMMARY OF THE INVENTION

A machine for performing a manufacturing process is disclosed using one or more exemplary embodiments for producing a block of construction material including harvesting tread strips from tires by receiving a strip of flexible material having a radial curvature memory in a first direction; perforating the strip of flexible material to produce crosswise plunge cuts into the flexible material from at least a first surface, wherein each crosswise cut each extends laterally across the width of the strip of flexible material, and wherein a depth of each crosswise cut is less than the thickness of the strip of flexible material; and bending the perforated strip of flexible material in a first curvature, wherein the first curvature produces a convex shape on the first surface, wherein the bending is along a longitudinal direction of the strip of flexible material, and wherein a force applied to the strip to achieve the bending is sufficient to break some of the flexible material contributing to the radial curvature memory.

### BRIEF DESCRIPTION OF DRAWINGS

The figures presented herein, when considered in light of this description, form a complete disclosure of one or more embodiments of the invention, wherein like reference numbers in the figures represent similar or same elements or steps.

FIG. 1 shows to a process according to the related invention for harvesting tread strips (elemental blocks) from tires and producing a block of construction material.

FIG. 2 illustrates a cross-section view of a typical vehicle tire to provide a reference for the components and terminology of the anatomy of typical tires.

FIG. 3 shows an exemplary process to remove most or all of the blocks and grooves (tread texture) from a tread cap.

FIG. 4 shows an exemplary tire cross section after removing away the tread texture and exemplary points of cutting through the tread cap well away from the shoulders.

FIG. 5 shows an exemplary cross section of a final tread strip yielded from the harvesting process, with an original internal liner as a bottom surface, exposed belt portions on the long edges and across the edges where it was cut from a circle to a strip.

FIG. 6 shows an exemplary two harvested tread strips stacked vertically on top of each other.

FIG. 7 illustrates the addition of a third tread strip to the stack of FIG. 6.

FIG. 8 provides a photograph of an actual block of seven tread strips produced using a process according to the related invention.

FIG. 9 shows a schematic of such a block as shown in FIG. 8.

FIG. 10 provides a perspective view of a partially-transparent rendering of a machine according to at least one embodiment of the present invention.

FIG. 11 illustrates a manner of use with additional details regarding the machine and the process performed by the machine of FIG. 10.

FIG. 12 shows a functional schematic of the process performed within the example machine of FIG. 10 and the example machinery to accomplish the example process.

FIG. 13 sets forth more details of an example penetrating drive barrel and accompanying set of penetrating idler barrels.

FIG. 14 shows an end-view from the input of the example embodiment provided in FIG. 10.

FIG. 15 sets forth more details of example embodiments of the opposing cutter wheels on the drive barrels according to at least one embodiment of the present invention.

FIG. 16 illustrates an example manufacturing process using the improvements provided by the process and machine according to at least one embodiment of the present invention.

### DETAILED DESCRIPTION

The present inventor has realized that the existing methods of reclaiming used and discarded vehicle tires are limited to either outcome-specific processes or shredding of the tires. For example, the present inventor was previously awarded U.S. Pat. No. 6,824,070 for a railroad cross-tie constructed from a stack of tire portions. While this was a useful end-product for a specific purpose, the end-product was not conducive to being used in products and fabrications other than a railroad cross-tie.

Therefore, the present inventor has realized that there is a need in the art for a tire reclaiming process that yields a product which is suitable for use as a solid raw material, not just a shredded raw material, for subsequent fabrication of a variety of products. At least one objective of the related invention is to yield a block of material from a plurality of reclaimed tires, wherein the yielded block is suitable for additional cutting, shaping, grinding, drilling, and fastening to fabricate other products, not just railroad cross-ties.

Another objective of the related invention includes, but is not limited to, avoiding the need for metal fasteners to keep the layers of reclaimed tire material flat. Another objective of the related invention includes, but is not limited to, avoiding the need for internal steel or metal plates within the yielded block, which have been taught by other sources as a requirement to strengthen and flatten such a block of material. Similarly, another objective of the related invention includes, but is not limited to, avoiding the need for internal membranes within the yielded block, which have been taught by other sources as a method to adhere laminate layers to each other. By eliminating some or all of fasteners, plates and membranes, the cost of the yielded product is reduced, the process complexity is decreased, and the weight of the block is reduced.

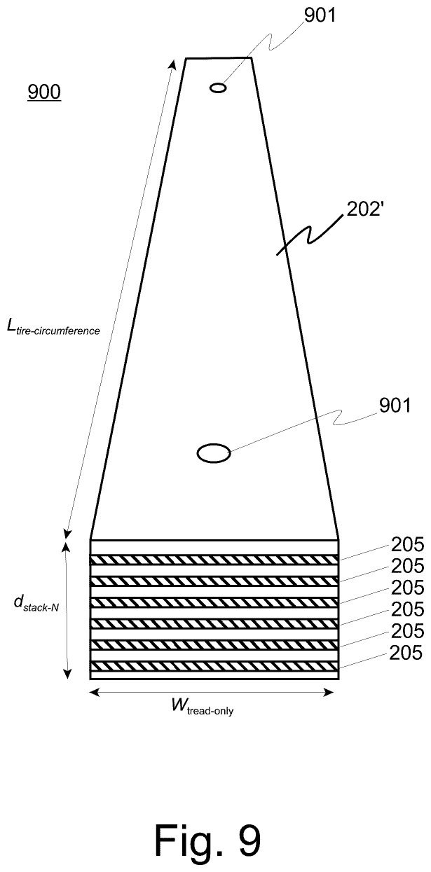

An example product yield 900 is shown in FIG. 9, which has a width w, a depth d, and a length L. In one embodiment, the width is that of a portion of the tread of the tires reclaim, wtread-only, the depth is that of a stacked plurality of reclaimed elemental work product dstack-N, and the length is that of the circumference of the tires which were reclaimed Ltire-circumference. In at least one embodiment, one or more index holes 901 are provided through the depth d of the block 900, in an essentially orthogonal direction to the surfaces of the elemental work product (layers). These index holes are voids for receiving vertically-oriented pins during the lamination process to align each layer to the previous, lower layer, as will be described in more details. The index holes are not necessarily used for fasteners, as the present method yields a block material which avoids the need for fasteners to retain the layers to each other. Laser drilling, water knife cutting, or standard drilling may be used to form these voids.

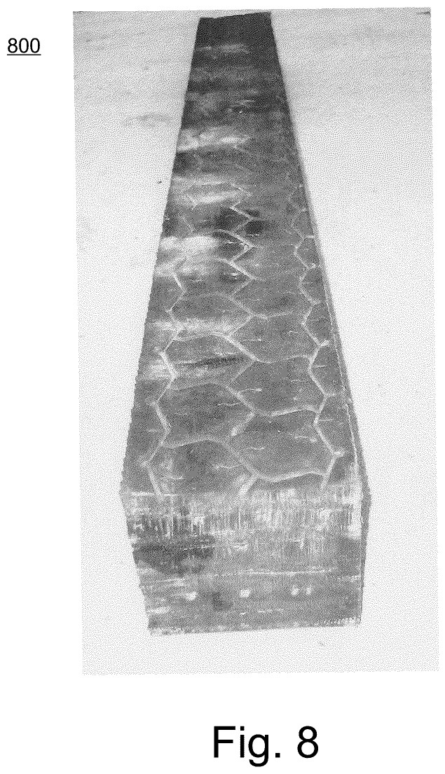

FIG. 8 is a photograph of an actual prototype building material block 800, without the indexing holes as shown in FIG. 9. In this photograph, the planarity of the block can be seen, even without the fasteners and internal metal plates of end-products of previous tire reclamation processes.

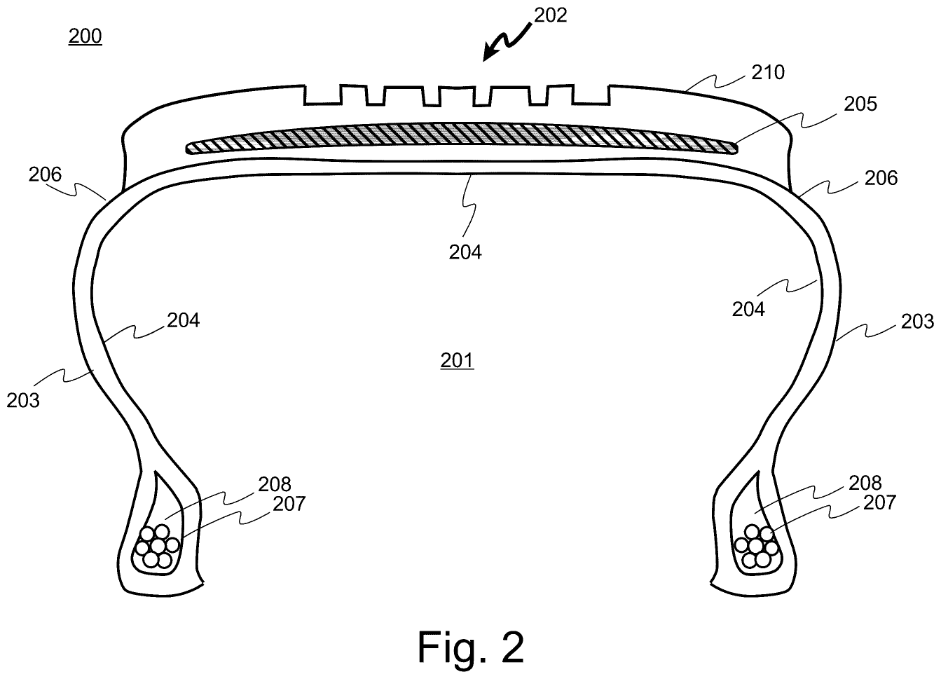

Turning to FIG. 2, a cross-section view of a typical vehicle tire 200 is shown, which has two side walls 203 and an interior liner 204 that compose a body for the tire. When mounted on a wheel, the body and wheel form an interior volume 201 for receiving pressurized air to inflate the tire. The tire typically is provided with two beads 207 running through a chaler 208, which provides the structure to maintain the tire on the wheel with an air-tight seal. The tread cap 210 is molded onto the outer portion of the body around the circumference of the tire, and includes a plurality of grooves, blocks, and channels 202 for gripping a roadway, and for channeling water, ice and snow away from the tire. The tread cap encapsulates one or more belts 205 which provide the structural strength of the tire to maintain its shape while under internal force for the pressurized air in the interior 201. The sidewalls 203 meet the tread cap 210 through a transitional bending portion, the shoulder 206. We will use these terms for the purposes of the present disclosure, while it will be recognized that some other terms as well as different tire architectures are well known in the art. The related invention is applicable to those other tire designs and descriptive terms, as well.

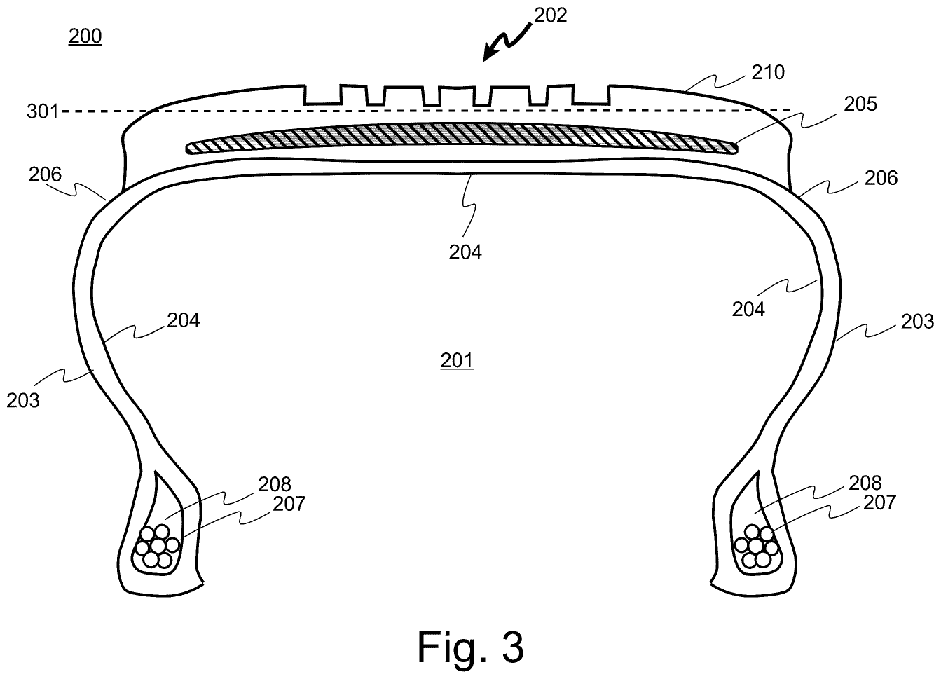

We will now describe a method according to the related invention of harvesting a strip of material from a tire for subsequent use in creating the material block as shown in FIGS. 8 and 9. FIG. 3 shows that the process removes most or all of the blocks and grooves from the tread cap to produce a substantially linear surface 301 on the outer circumference of the tire. In one embodiment, this is done by mounting the tire onto a wheel, inflating the tire, and rotating the tire while applying a rasp across the tread area until the desired amount of tread reduction has been achieved. The crumbs produced by the rasping operation may be used as a byproduct for other purposes.

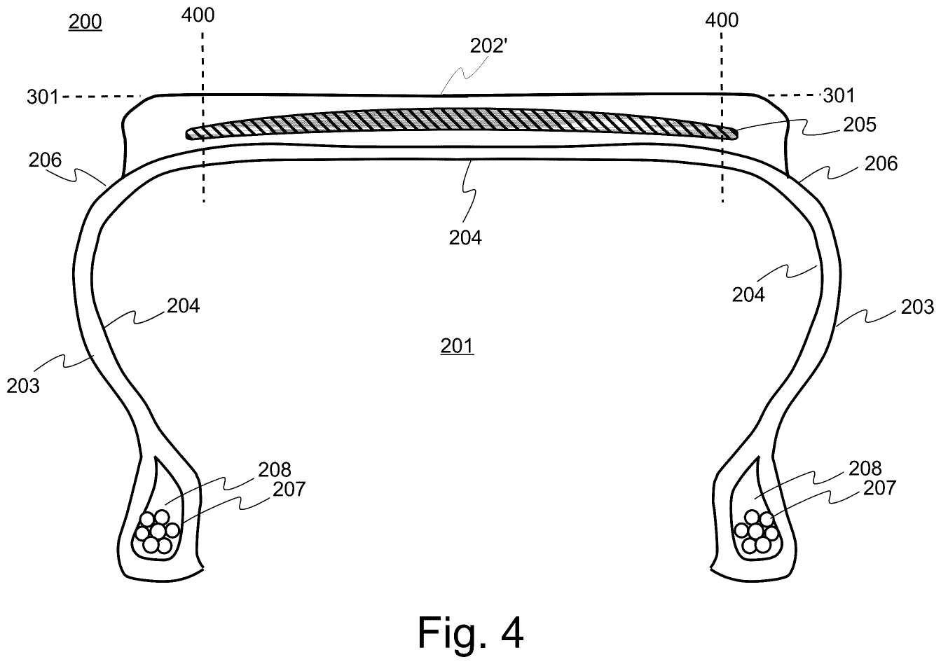

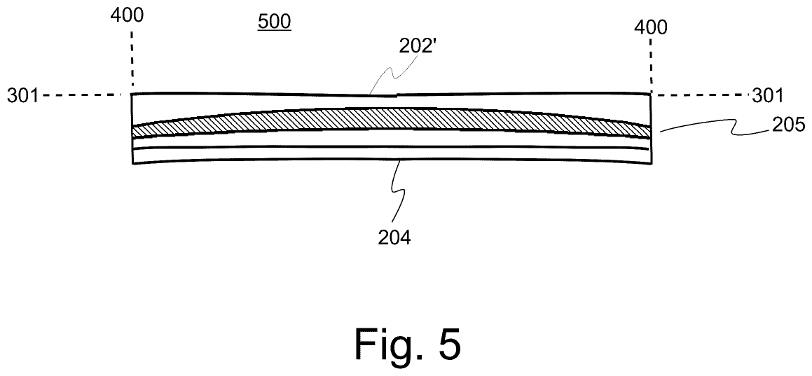

FIG. 4 shows the tire cross section 200 after rasping away the thread, with a new, and typically rough, surface 202′ around the periphery of the tread cap. The tire is next subjected to cutting, by blade or water knife or other suitable means, orthogonally through the tread cap at points 400 well within the tread away, and well away from the shoulders 206. In previously-known and previously-used methods, the cutting was performed through the thinner, more-easily cut shoulders. However, cutting at the shoulders leaves a portion of the shoulder depending inwards towards the center of the tire, which causes the subsequent strip to want to curl, and the requires internal plates and fasteners to force into a flat or planar position. In the related invention, this problem is avoided by cutting 400 through the tread cap away from the shoulder, and typically through the extreme edges of the belts 205. This is a more difficult cut than cutting through the shoulders, but yields a must flatter strip of material when the final cut across the width w of the tread cap is made. FIG. 5 shows the cross section of the final strip 500 yielded from the harvesting process, with a rough upper surface 202′ from the rasping, the original internal liner 204 as a bottom surface, and typically exposed belt portions 205 on the long edges and across the edges where it was cut from a circle to a strip. This strip now serves as an elemental block of material to be used as a layer in the final end-product.

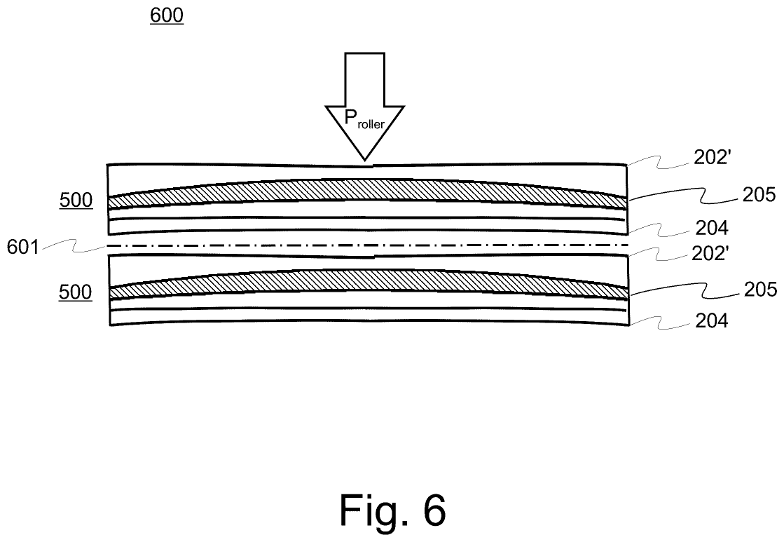

FIG. 6 shows how two elemental blocks 500 are stacked vertically on top of each other, optionally using the aforementioned indexing holes and pins. The bottommost (first) layer is pre-heated, and a layer of pre-heated gum 601 is applied to the rough top surface 202′ of it. A second pre-heated elemental block is then laid on top of the first layer, capturing the gum layer between its bottom surface 204 and the top surface 202′ of the bottom layer. Because of the slight internal curvature of the bottom surface 204 of the second layer, a small gap may form between the two layers. So, while maintaining both layers in a heated environment, downward pressure Proller is applied by roller in a sufficient force to press way this gap.

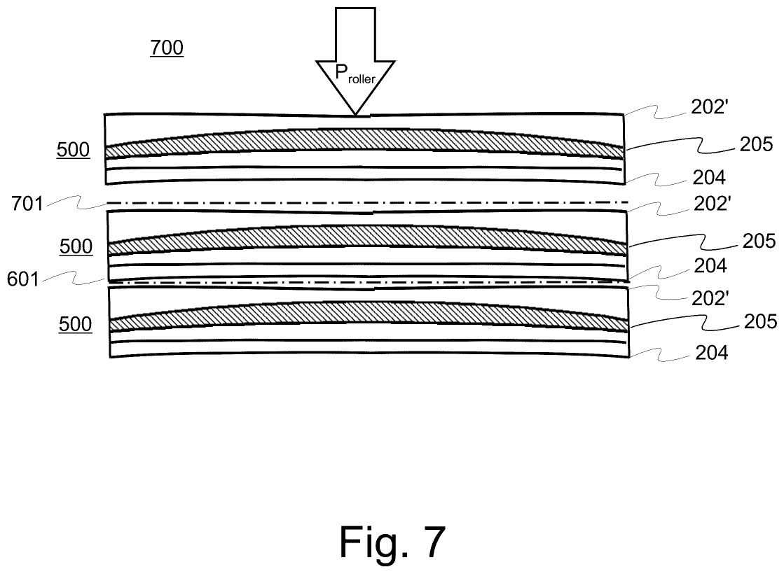

While maintaining the first two layers in a heated environment, a second pre-heated layer of gum 601 is applied to the rough top surface 202′ of the second layer, and third pre-heated elemental block 500 is laid on top of the second layer, capturing the second gum layer 701 between its bottom surface 204 and the top surface 202′ of the second layer, as shown in FIG. 7. And, as before, downward pressure Proller is applied by roller in a sufficient force to the top surface 202′ of the third layer to press way any gap between the second and third layers, while maintaining all three layers in a heated environment.

This process is continued by adding additional individual layers with interposed gum layers in a heated environment, and pressing out any gaps as required, until the desired depth d is achieved for the final work product, as shown in FIGS. 8 and 9. In one embodiment of this process, the final work product has a depth equal approximately to the thickness of the harvested blocks times the number of layers laminated together, a width equal to the distance between the cut points 400 through the tread cap, and a length approximately equal to the outer periphery of the tire.

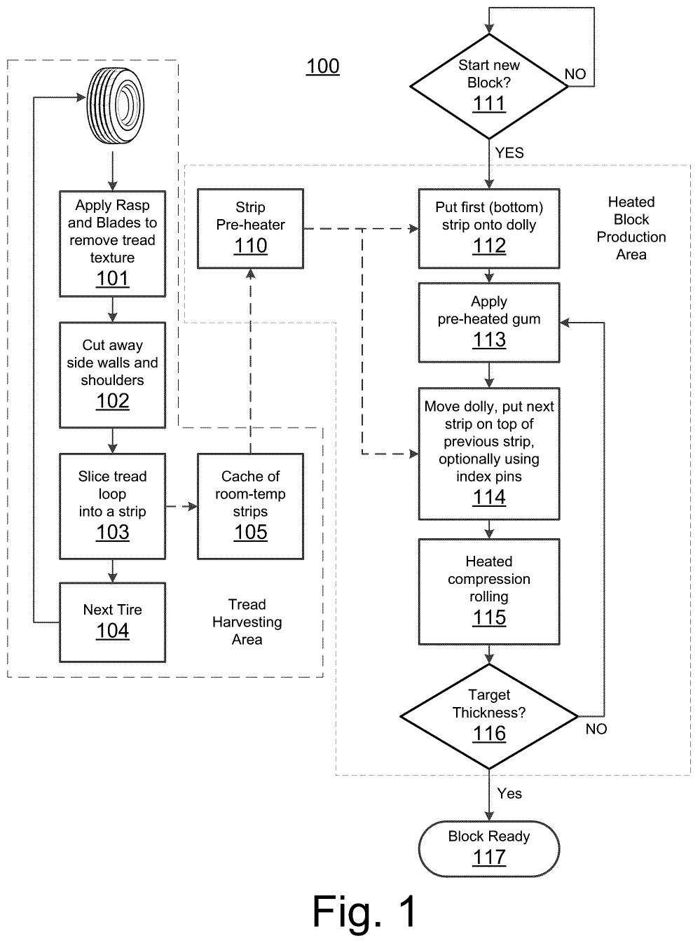

Referring now to FIG. 1, a process 100 according to the related invention for harvesting tread strips (elemental blocks) from tires and producing a block of construction material is shown. A tire is received onto a wheel and inflated. Then, the wheel and tire are spun while a rasp, blade, grinder or other device is applied to the tread on the periphery of the tire to remove 101 the tread texture. In some embodiments, all of the tread texture may be removed, while in other embodiments, part of the tread texture may be removed. The yielded crumbs can be collected and used or sold as a process by-product, but are not otherwise needed in the rest of the process according to the related invention.

After removing the tread texture, the side walls and shoulders are removed 102 from the tire, such as by cutting through the tread cap using blades, lasers, water knives, etc., at a point 400 away from the shoulders and into the tread cap itself, thereby completely separating the sidewalls and shoulders from the tread loop. The yielded sidewall-shoulder portions can be collected and used or sold as a process by-product, but are not otherwise needed in the rest of the process according to the related invention.

The tread loop is then sliced 103 across the width of the tread cap to produce a tread strip having a thickness of the tread cap plus the inner liner and body portion minus the thread depth removed 101, a width of approximately the tread width of the tire (less shoulders' width), and a length approximately the circumference of the uninflated tire. The tread strip is then cached 105, optionally at room temperature, until it is integrated into a material block, and the next tire 104 is prepared (mounting, inflating) for tread texture removal 101.

Continuing with the portion of the illustrated process 100 according to the related invention, a first tread strip is pre-heated 110, preferably to 160° F. to 250° F. using an infrared (IR) heat source, and optionally one or more index holes are formed into the strip in a direction through the top surface 202′ and the bottom surface 204. The tread strip is then placed 112 onto a dolly or cart in a heated production area to maintain the heated temperature of the tread strip, optionally with one or more index pins protruding upwards from the dolly and through the one or more index holes in the tread strip. This first strip becomes the bottom strip of a multi-strip stack to be produced into a building material block.

Next, pre-heated gum is applied 113 to the top surface 202′ of the first strip. Gum pre-heating is preferably performed to 160° F. to 250° F. The dolly, while still in a heated production area, is moved 114 to receive a second pre-heated 110 strip, optionally aligning the second tread strip vertically on the first tread strip using the index pins and holes.

Now, the first two tread strips are compressed 115, preferably using rollers, to remove any gaps between the slightly curved bottom surface 204 of the second tread strip and the top surface 202′ of the first (bottom) tread strip. The two tread strips remain on the dolly, as the gum application 113 is repeated on the top surface 202′ of the second strip, the dolly is moved to receive a third pre-heated 110 third tread strip, and the pressing 115 is applied to the three-strip stack of materials. This process is repeated 116 until the desired depth dstack-N is achieved using N tread strips. For example, when using long-haul truck tires as the source material, a stack of seven harvested tread strips will yield a depth of approximately 8.25″, a width of about 10″, and a length of about 10′.

After cooling, the final produced block of building material is now ready 117 for packaging and shipping to a consumer for further use in end-user products. Not shown in this exemplary process 100 according to the invention may be additional grinding, cutting, shaping, sealing, painting, coating, etc., to adjust the final dimensions, UV resilience, color, and/or surface texture or ornamentation.

Telescoping Index Pins. In one enhanced embodiment, the dolly is equipped with telescoping or otherwise extendable indexing pins to be received in the index holes 901 which are optionally provided through the depth d of the block 900. In this manner, the indexing pins can be retracted such that they initially only extend through and above the first tread strip on the dolly an amount sufficient for aligning the second tread strip, but not further. This allows handling equipment to move freely horizontally across the top of the stack while minimizing vertical movement to place the second tread strip on top of the first tread strip, and may also reduce interference of the indexing pins with the mechanisms which apply the pre-heated gum to the top of the first tread strip.

Then, when a third tread strip is to be added to the stack, the indexing pins are extended just above the second strip enough to receive the third strip, but not to protrude through the third strip, and so forth, until the final tread strip is added to the stack.

Agricultural Fence Post. In additional cutting, shaping, grinding, and drilling operations, the block construction material made of the stacked tread strips can be fabricated into a fence post suitable for agricultural use, such as by providing holes or notches to receive barbed wire, welded wire mesh, cross members, slats, etc.

Cross-traffic Vehicle Catcher Post. In additional cutting, shaping, grinding, and drilling operations, the block construction material made of the stacked tread strips can be fabricated into a post suitable for use with roadway cross-traffic vehicle catcher systems, such as by providing holes or notches to receive the taught cables which run horizontal in such systems.

Dock Bumper. In additional cutting, shaping, grinding, and drilling operations, the block construction material made of the stacked tread strips can be fabricated into a bumper suitable for use on loading docks for long-haul trucking distribution warehouses, as well as bumpers for boats on docks.

Railroad Crosstie. In additional cutting, shaping, grinding, and drilling operations, the block construction material made of the stacked tread strips can be fabricated into a crosstie suitable for use in a railway bed.

Machine and Method to Flatten Harvested Strips. As mentioned in the foregoing paragraphs, one of the challenges with the processes and machines of the present art is that the harvested strips retain a strong curvature memory and they resist being flattened. The curvature memory can be attributed to two parts of the harvested strip. A first contributor is that the rubber-like material along the former interior surface has a slightly shorter length than the length of the compound material along the former middle of the tire (just below the embossed tread). In other words, the new top of the strip is slightly longer than the new bottom of the strip due to the differences in the circumference of the interior of exterior of the tire compared to the interior of the tire.

Second, if the tire was built using belts between the plies, the material of the belts (e.g., steel, fiberglass, rayon, etc.) is stronger than the rubber-like material, the belts closer to the interior of the tire are slightly shorter in length than the belts closer to the exterior of the tire. These strong belt components provide significantly to the curve memory of the harvested strip, preventing it from taking a flat form without significant pressure.

Realizing this through practice and experimentation, the present inventors have devised a new type of machine and process to use the machine to release a significant amount of the curve memory of strips harvested from tires. While a first objective is to process the strips to remove most or all of the curve memory, a second objective of the present invention is to avoid damaging the strip in any manner that would render it less desirable for the previously-mentioned subsequent constructions and uses. A third objective is to accomplish this curve memory reduction without using materials, such as chemicals, hazardous steps, such as heat, or producing by-products, such as shreds or additional crumbs.

The present inventors, therefore, developed generalized process which they refer to as “radial cluster busting” (RCB), and at least one example machine to perform the process. Additionally, this new machine can be used to improve the previously-described process to harvest, prepare and build products from strips of tires.

The teachings of U.S. Pat. No. 6,824,070 B2, issued on Nov. 30, 2004, to Rick Halverson and Martin Diamond, and U.S. Pat. No. 10,315,391 to Richard G. Halverson, provide two example processes and products which may benefit from the improvements taught in the present disclosure. However, those ordinarily skilled in the arts will recognize that the improvements, processes and machines disclosed herein may equally well be utilized in other processes and other products made from reclaimed and harvested portions of tires.

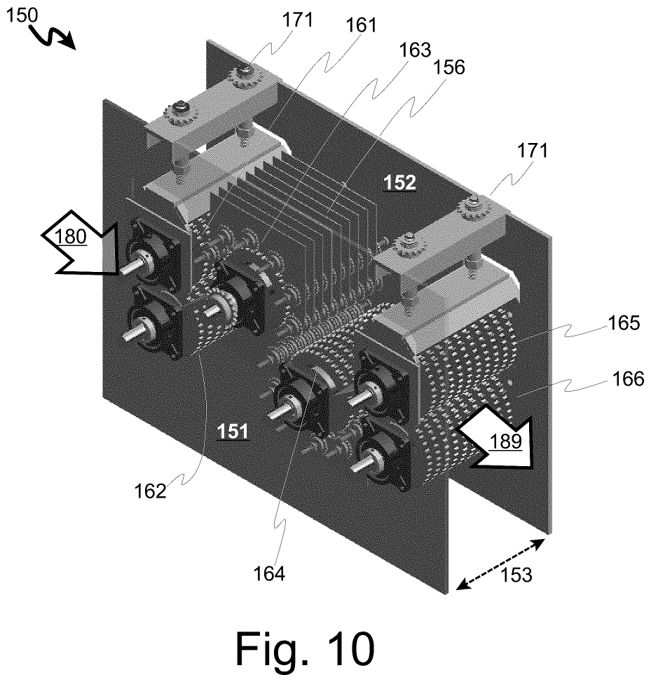

Turning now to FIG. 10, an example machine embodiment 150 to practice the process and method of the present invention is shown. This particular example machine has a frame with a front support plate 151 and a rear support plate 152 separated by a distance 153 suitable to receive 180 a strip of harvested tire material lengthwise. Other embodiments might be configured to receive a strip of harvested tire width-wise for greater throughput, within the scope of the present invention.

The strip is processed through a series of internal steps, and emerges 189 out the other side. This example processes strips from left to right, but other embodiments may process strips in other directions, such as right to left, top to bottom, etc.

In this perspective view, the front support plate 151 is rendered with some transparency so that some of the internal mechanisms are visible in their arrangement, including driven six penetrating drive barrels 161-166 and, in this example, a plurality of undriven penetrating idlers barrels (not numbered in this view, but numbered in subsequent drawings). Also visible in this rendering are two example adjustable barrel positioners 171. This may be manually adjustable, machine adjustable (e.g., automated adjustment), or both, and they may set a static position between a paired barrel or they may include devices such as springs or pistons in some embodiments to allow for some “give” or leeway in the spacing set between corresponding penetrating barrels. Both the inter-barrel spacing and the pressure they 171 exert are variables in how deeply a strip of harvested tire material is penetrated during the process. One can see in this view that this embodiment uses a general barrel configuration of an axle supported by the front and rear plates 151, 152, by typical means, such as a bearing assembly.

Along each axle are configured a number of penetrating wheels or cogs, to be discussed in more details in the following paragraphs, according to at least one embodiment of the present invention. The axles are provided with typical features, such as a flat side, for receiving a gear or pulley (not shown on the axle in this view) to receive rotational energy from a source such as an electric motor, fossil fuel engine, etc., via a drive chain or belt. Direct drive (e.g., gear to gear) is possible in some embodiments according to at least one embodiment of the present invention. In this embodiment, gear (or pulley) ratios are selected so that the tangential velocities of each penetrating barrel equals that of all the other penetrating barrels. This prevents the strip of tire material from being stretched or compressed along the processing pathway 180 to 189, according to at least one embodiment of the present invention. In other embodiments, such linear stretching may be desired, so the various gear diameters (or pulley diameters) may be adjusted according to the desired differences in tangential velocity variations long the processing pathway. Also visible in this perspective rendering is an example configuration to support the plurality of idler penetrating barrels, such as a series of parallel plates 156 with associated space and pressure setting hardware (not shown in this view).

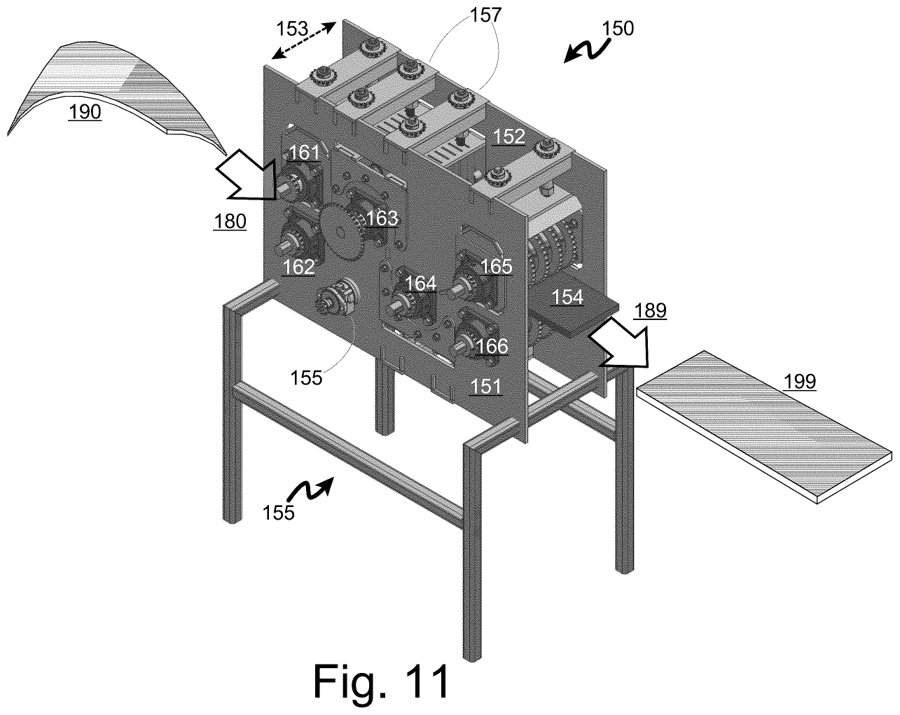

Turning now to FIG. 11, the example machine embodiment 150 is shown on a shop or factory floor stand 155. Other embodiments may be table or bench top units, free-standing enclosed units, trailer or truck mounted units, etc., within the scope of the present invention. This view renders the front support panel 151 in solid, and it illustrates how a harvest strip of tire material with curvature memory 190 is received into the processing pathway 180 to 189, the output of which presents the processed strip of tire material 199 (e.g., flattened with curvature memory relaxed). This view also shows example gears attached to the axle ends of the driven penetrating barrels 161-166 to receive a drive chain (not shown), and driven by an example electric motor 155 output shaft, according to at least one embodiment of the present invention. And, in this particular example, an output shelf 154 is shown, on top of which the processed strip 199 emerges from the processing pathway 180 to 189. Further included in this view is example hardware 157 for setting the gap between a set of undriven idler penetrating barrels and an associated driven penetrating barrel 163, which were omitted from FIG. 10 in order to show other features more clearly in FIG. 10.

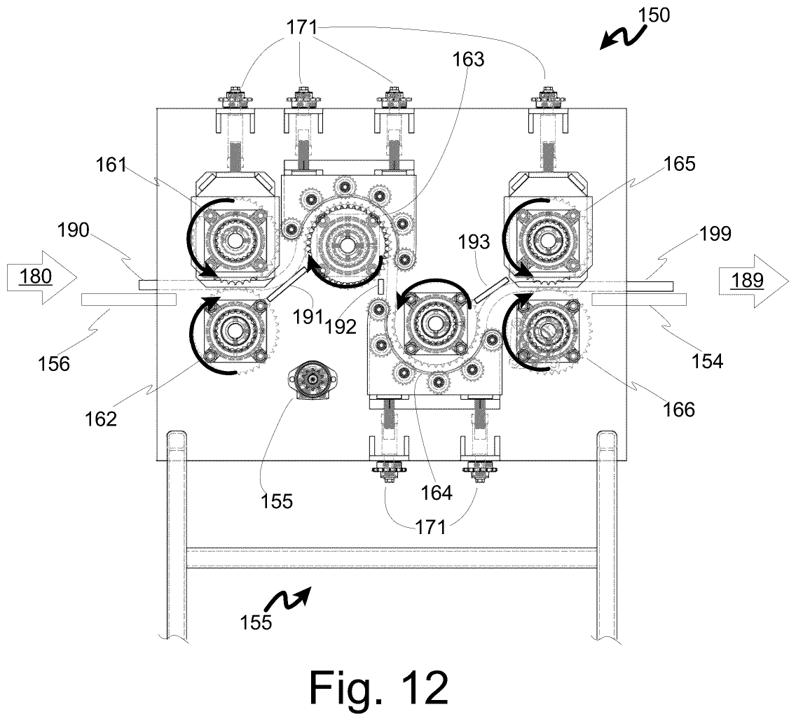

Referring now to FIG. 12, a functional schematic taken from a front perspective of the example machine 150 of FIGS. 10 and 11 is shown. The processing pathway has an input shelf 156 and an output shelf 154 in this configuration, but in other configurations, a machine performing this memory releasing function may be interfaced directly into other material handling and processing machines and devices, such as conveyors, robotic handlers, etc. As the tire strip with curvature memory 190 is received 180 into the processing pathway, it is first met by a pair of driven penetrating barrels 161 and 162, between which it passes for a first stage of processing. In this stage and example embodiment, the strip is penetrated from above and below, the depth of the penetrations being controlled by the setting hardware 171. While example dimensions of widths and depths of the penetrations will be given in the following paragraphs, it should be noted that most configurations according to at least one embodiment of the present invention will not fully penetrate all the way through from top to bottom, or vice versa, the tire strip. If one were to compare this to a mechanical meat tenderizer, the process is generally configured to make surface penetrations, but not to make through-perforations (like cubed steak). In other configurations, however, such as a configuration intended to stretch the strip of tire material beyond its original length, such through-perforations may be accomplished by such a machine as well.

As the first stage barrels 161 and 162 turn in the cooperating directions as shown by the arrows, the strip is directed rightwards and then upwards (approximately 90 degrees) by a first deflection plate 191 into a second stage of the processing pathway. During this upwards bend of the material, the penetrated bottom portion of the strip of material is stretched to break open the penetrations, so that any material which was not complete cut by the penetration teeth is now torn free. If the strip was loaded onto the input table 156 with its curvature memory facing downwards (e.g., the original inside surface of the strip material on bottom), then this first turn provides an anti-curvature bend of the material to begin to break the material causing the curvature.

As the strip proceeds into the second stage, it is penetrated according to at least one embodiment of the present invention by the teeth (or blades) of a larger driven penetrating barrel 163 as it is received in the gap between a plurality of idler penetrating barrels. In some embodiments, the depth of penetration in the second stage is the set to be the same as in the first stage, and in other embodiments, it may be different (deeper, shallower, wider, narrower, closer spacing, wider spacing, etc.), allowing for more flexibility to process a wider array of possible harvested strips of material. As the strip completes the second stage, it is bent around and conformed to the outside circumference of the larger penetrating barrel 163, bending it in the opposite direction that it was subject to by the first deflecting plate 191. Just in case there is some curvature memory still present at the leading edge of the strip, one or more guides 192 may be provided to urge the strip into the third stage of processing.

In the third stage of processing, the same arrangement of the second stage is utilized except with vertical symmetry—the strip is received into a gap between a second large penetrating barrel 164 and its associated idler penetrators, in which it is penetrated by more teeth (same or different penetration parameters) and conformed around the second large penetrating barrel's circumference to bend the strip in the opposite direction, again. This further releases curvature memory from the strip.

To complete the processing pathway in this example machine, the strip is passed into a fourth stage (penetrating barrels 165 and 166) which is similar to the first stage of processing, with deflection plate 193 provide one last bend to break any remaining fibers or materials in the penetrations and release the reset of the curvature memory. The processed strip 199 emerges at the output, such as on an output shelf 154 according to at least one embodiment of the present invention.

Please note that this particular embodiment of a machine to perform the process according to at least one embodiment of the present invention provides vertically-symmetric stages, penetrating and bending the strip of material equally in both upwards and downwards directions. In this example embodiment, the original strip of material with curvature memory would be equally well processed whether it was loaded with the curvature facing downwards (e.g., convex surface on top, concave surface on bottom) or with the curvature facing upwards (e.g., convex surface on bottom, concave surface on top). In other embodiments in which the curvature memory orientation of the strip is expected to be only one direction or the other, the stages may be provided with more or less curves, bends and breaks in the direction to process one surface of the strip more than the other surface. And, in some configurations, the parameters of the cutters on the penetrating barrels may be set with the expectation that each barrel will only be penetrating the convex or concave surface, but not both surfaces, for even greater control and customization of the curvature breaking benefits of the process and machine.

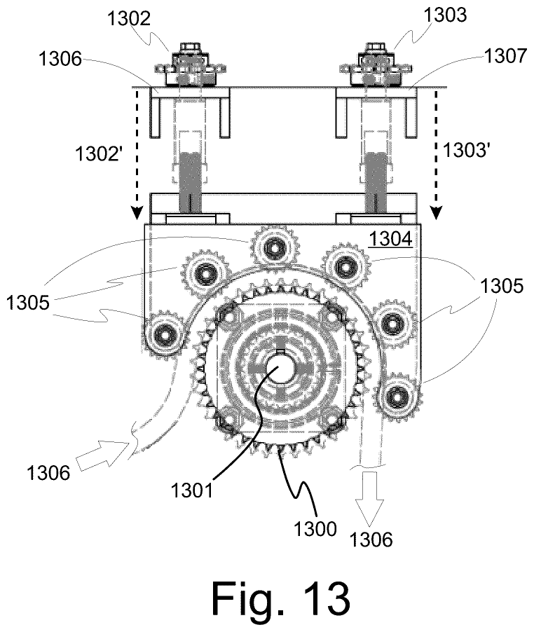

FIG. 13 provides greater details of a large penetrating barrel 1300 with a plurality of idler penetrating barrels 1305 to conform a strip of material 1306 around the barrels and through the gap between them. More details of the example support hardware in the form of one or more parallel plates 1304 can be see according to at least one embodiment of the present invention, as well as the hardware 1302 and 1303 to set the gap distance 1302′ and 1303′, and optional pressure level, between the idler barrels and the large barrel. In this example, lateral U-shaped supports 1306 receive the end of the adjusters 1302 and 1303, the supports extending between the front support plate 151 and the rear support plate 152 as shown in FIG. 11. With two adjusters, one could potentially increase or decrease the spacing between the barrels as the strip passes around the larger barrel, providing a possible option of variable penetration depths for some process requirements.

In FIG. 13, more side-view details of the cutters (teeth, blades, etc.) around the penetrating barrels can be seen. While these may appear to be gear teeth, they are actually sharpened edges which extend in the same direction as the axle 1301 on which their carrying discs ride. Each cutter makes a short cut into the strip material across the width of the strip material. Because the bending will be exerted around the length of the strip of material, each cross-width cut will be stretched open at one or more stages of the process.

Further, when the harvested tire strip contains belts or fiber reinforcements, they will generally be encapsulated in the tire material in an orientation running entirely or partially along the length of the harvested strip of tire material. Since the belts or fibers are usually laid into the tire in vertical layers, those closest to the former interior surface of the strip are shorter than those closest to the former exterior surface of the tire, and thus they provide a strong contribution to curvature memory. As such, these plurality of crosswise (across the width of the strip) cuts or slices will cut the belts or fibers into lengthwise segments, thereby segmenting their contribution to the curvature memory into smaller and smaller lengths until, at some point of processing, the segments are so small that their contribution to curvature is nil or negligible.

The example structure of FIG. 13 can be vertically inverted to produce the symmetrical processing stage, of course, as previously discussed.

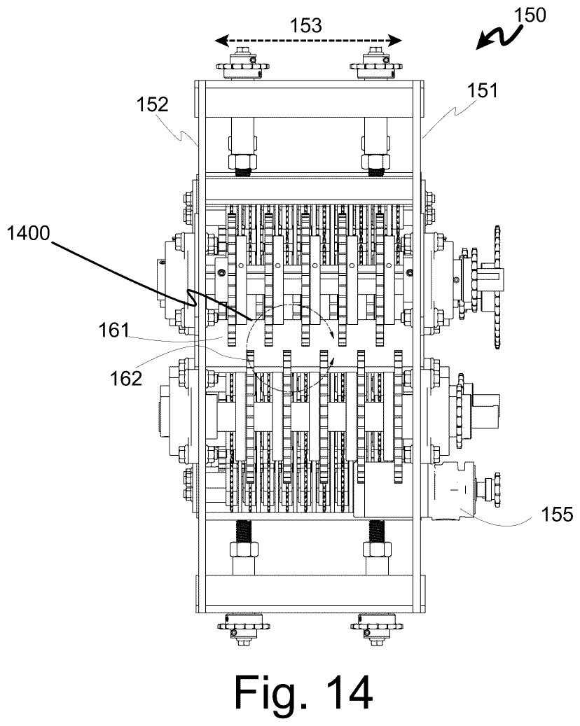

FIG. 14 provides a view from the input (left) side of the example machine 150 of FIGS. 10-11, with the front support plate 151 and the rear support plate 152 providing a space 153 between them to house the penetrating barrels and to receive the width of the tire strip to be processed. In this view, one can see that the cutting wheels of the pairs barrels are arranged in a horizontally offset manner (left to right in this view) according to at least one embodiment of the present invention. In this way, the strip of material is not subjected to penetrations by cutter wheels which are directly located above and below each ohter, which minimizes the chance that the blades of opposing cutter wheels will come into contact with each other, potentially damaging them. And, it minimizes the likelihood that the tire material will be perforated all the way through the thickness of the material. In some other embodiments in which the orientation of the curvature of the strip of material is to be only one way or the other (facing up or facing down), some of the barrels may have more cutter wheels than other barrels in order to provide more penetrations to the concave side of the strip. In this particular machine example, the configuration is vertically symmetric so that the strips may be inserted into the processing pathway with the curvature oriented in either direction.

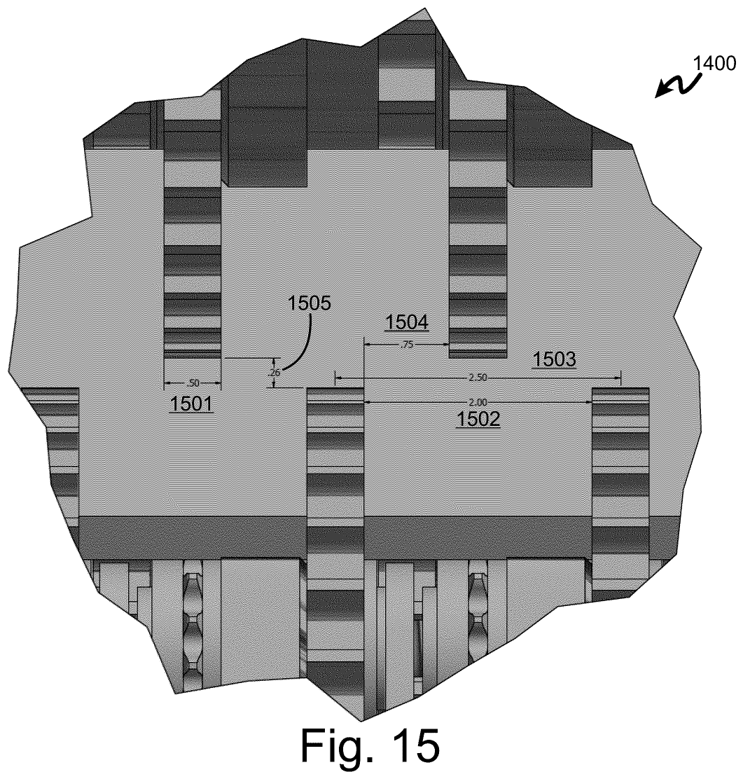

FIG. 15 provides more details of the vertically symmetrical cooperating cutter wheels in the area 1400 highlighted in FIG. 14. The dimensions provided on FIG. 15 are for an example embodiment to process large truck tires. Other dimensions and spacings may be realized in other embodiments for processing other types of strips harvested from other types of tires, belts, and similar products. In this pair of cutter wheels, the blades are 0.50″ wide 1501 to create penetrations across the width of the strip of the tire material (e.g., slices oriented from side-to-side). And, the outer most edges (measured from the center of the axles) of the opposing sets of cutters are set to be about 0.26″ apart 1505, creating a gap for receiving the tire strip into, and providing a portion thickness within the center of the tire strip in which will not be cut at all. For example, if the tire strip is 1″ thick, it may receive penetrating cuts 0.50″ wide and 0.37″ deep from both the top and bottom surfaces, leaving a middle portion 0.26″ of the material uncut to provide a continuous connection between the penetrated top and bottom portions, with these settings on the machine.

Further, in this example embodiment, the top and bottom opposing cutting wheels are offset 1504, edge to edge, by 0.75″, putting them on 2.50″ centers 1503 across each surface, with an opposing cutter centered approximately on the other side of the material. When viewing one surface or the other, one would see crosswise slices 0.5″ wide 1501 with 2.00″ from the end of one slice to the beginning of the next slice 1502, as measured across the width of the strip of tire material.

Other criteria, dimensions, and spacings for the cutters may be adopted, through the example adjustments and/or by changing the cutter wheels themselves, to achieve the processing needs and objectives for a wide variety of input strip material types. The foregoing example is for illustration and does not represent the full breadth and scope of the present invention.

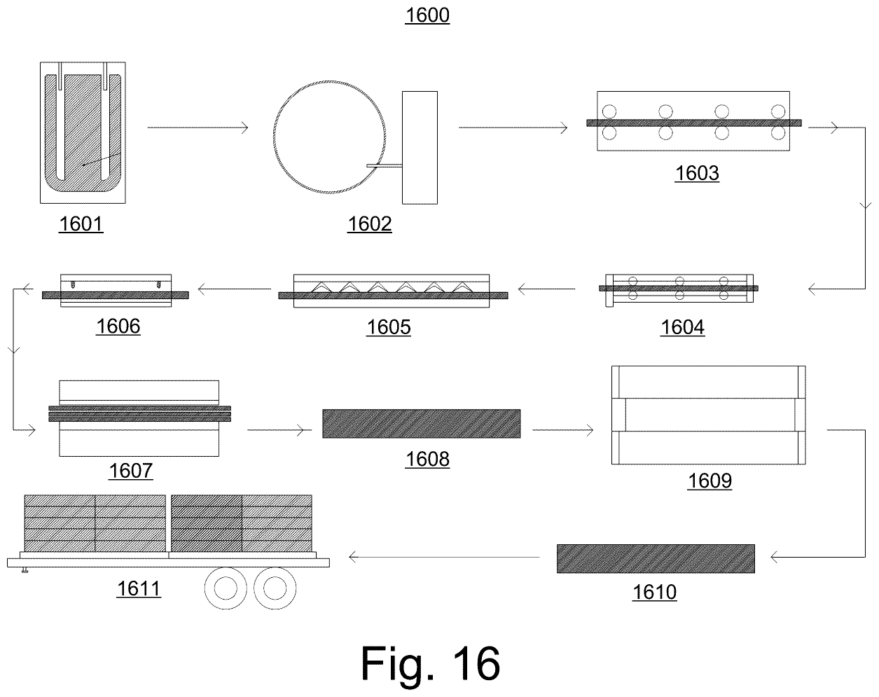

FIG. 16 illustrates an improvement to the tire strip harvesting and example end-product manufacturing process of FIG. 1. Other processes may benefit from this machine and curvature reducing method, or the machine and method may be used separately from any other process just to produce flattened strips for subsequent use in other ways. In the example improved process 1600, the embossed tread may be optionally removed by a rasp, knife, or other machine as previously discussed, to yield a “bald” tire. The tire sidewalls are cut and removed 1601, and the remaining loop of tire material is cut crosswise 1602 to yield a strip of tire material (with curvature memory). Then, the harvested strip with curvature memory is subjected to a process and machine according 1603 according to at least one embodiment of the present invention, which provides an improved, flatter strip of material for subsequent used. Next, the strip may be put through a buffer 1604 to smooth out any rough edges on the strip, and then a gum rubbber extruder 1605 may spread adhesive to at least one surface of the flattened strip.

Then, in the case of railroad tie manufacturing from the strips, the strip may be drilled 1606 to provide holes to receive railroad tie spikes. Next, the strip may be added and pressed 1607 onto a stack of other strips to further assemble a block of product. Then, when the stack is complete, it may be heated 1608 in an oven 1609 to adhere the strips to each other into a unitary block of material, yielding a final product such as a 10″×7″×10′ railroad tie, other product or even just a block of material for sale and machining into other products. The completed product 1610 may then be packaged and shipped 1611, accordingly.

Alternative Radial Cluster Buster Embodiment(s). Other embodiments of the present invention (machine and process) may separate the perforating operations from the bending or flexing operations. For example, the perforations may be made into a harvested strip of tire material using a set of blades, cutting crosswise (side-to-side), and then bending or flexing the perforated strip in a step or steps subsequent to the perforating operation. One such example would be to “stamp” perforations into the curved harvested strip, and then forward the perforated strip to a bending stage, repeating the pair of steps as much as necessary to achieve a desired amount of flatness.

Conclusion. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the related invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be readily recognized by those skilled in the art that the foregoing example embodiments do not define the extent or scope of the related invention, but instead are provided as illustrations of how to make and use at least one embodiment of the related invention. The following claims define the extent and scope of at least one invention disclosed herein.

What is claimed is:

1. A process for producing a flattened strip of construction material comprising the steps of:
receiving, by a machine, a harvested tread from a tire comprising a strip of flexible material having a radial curvature memory in a first direction, and having a length, a width, a thickness, a top surface and a bottom surface;
perforating, by a machine, the strip of flexible material to produce a plurality of crosswise plunge cuts into the flexible material from at least a first surface, wherein each crosswise cut each extends laterally across the width of the strip of flexible material, and wherein a depth of each crosswise cut is less than the thickness of the strip of flexible material; and
bending, by a machine, the perforated strip of flexible material in a first curvature, wherein the first curvature produces a convex shape on the first surface, wherein the bending is along a longitudinal direction of the strip of flexible material, and wherein a force applied to the strip to achieve the bending is sufficient to break some of the flexible material contributing to the radial curvature memory.

2. The process as set forth in claim 1 wherein the steps of perforating and bending are repeated for a second surface and a second curvature, respectively.

3. The process as set forth in claim 2 wherein the second surface and the second curvature comprise an opposite surface to the first surface and an opposite curvature to the first curvature, respectively.

4. The process as set forth in claim 2 wherein the perforating is performed by a pair of perforating barrels of blades disposed on opposite sides of the strip of material, thereby compressing and perforating the strip of material between the pair of perforating barrels of blades to perform perforating on two opposite sides in a single stage.

5. The process as set forth in claim 1 wherein the perforating is performed at least in one stage of processing by a perforating barrel of blades.

6. The process as set forth in claim 1 wherein the perforating and bending are performed by a larger diameter perforating barrel of blades and a set of smaller diameter perforating barrel of blades disposed around at least a part of a periphery of the larger diameter perforating barrel of blade, with a space therebetween for receiving the strip of flexible material, thereby performing the steps of perforating and bending simultaneously.

7. The process as set forth in claim 1, further performing steps comprising:
prior to the step of receiving a harvested tread, harvesting a tread by:
removing, by a machine, a tread texture of a tread cap from a tire using a tread removal device while leaving a remaining portion of the tread cap intact with one or more sidewalls and shoulders of each tire;
removing, by a machine, one or more side walls and entire shoulders from the tire by cutting through the remaining portion of each tread cap; and
slicing, by a machine, the remaining portion of the tread cap across a width of the tread cap to produce a strip of flexible material harvested from the tire; and
subsequent to the step of bending:
preheating the previously-bent strip of flexible material to a temperature between 160° F. to 250° F., inclusive;
while maintaining the temperature of the previously-bent strip of flexible material, stacking a the previously-bent strips of flexible material upon each other subsequent to disposing a pre-heated gum between each pair of tread strips and applying compression force to flatten and remove gaps between the stacked strips; and
allowing the gummed, stacked and pressed strips to cool, thereby yielding a block of construction material while avoiding the use of fasteners, plates and membranes to maintain the stacked strips into a block arrangement.

8. The process as set forth in claim 7 in which the removing of tread texture is performed by one or more tread removal devices selected from the group consisting of a rasp, a blade, and grinder.

9. The process as set forth in claim 7 wherein, prior to the removing of tread texture, the tire is mounted in a wheel, the tire is inflated, and wherein the step of removing tread texture further comprises spinning the wheel and tire while applying the tread removal device.

10. The process as set forth in claim 7 wherein the cutting through the remaining portion of each tread cap is performed at least in part using a cutting device selected from the group consisting of a blade, a laser, and a water knife.

11. The process as set forth in claim 7 wherein the cutting through the remaining portion of each tread cap comprises cutting through the tread cap at a position which cuts through one or more belts in the tread cap.

12. The process as set forth in claim 7 wherein the pre-heating is performed using one or more heating devices selected from the group consisting of an infrared light source, a heated air source, a convective heat source, a conducted heat source, and a heated liquid source.

13. The process as set forth in claim 7 further comprising:
prior to the stacking, providing one or more holes through each strip; and
during the stacking, employing one or more indexing rods through the one or more holes through each strip to maintain alignment of the stacked strips.

14. The process as set forth in claim 7 wherein the stacking is performed by accumulating the stacked strips onto a moveable dolly, and wherein the moveable dolly shuttles between a gum-application position, a next-tread-strip-stacking position, and a compression position, while maintaining the stack at the pre-heated temperature.

15. The process as set forth in claim 7 wherein the yielded block of construction material comprises seven strips, and has final block dimensions of approximately 8.25 inches deep by approximately 10 inches wide by approximately 10 feet long.

16. The process as set forth in claim 1 further comprising one or more post-production steps selected from the group consisting of grinding, cutting, shaping, sealing, painting, and coating, to adjust one or more characteristics of the material block selected from the group consisting of the final dimensions, the final shape, ultra-violet light resilience, exterior color, exterior surface texture and exterior ornamentation.

17. A machine for producing a block of construction material comprising:
a processing pathway defined between an input and an output;
one or more perforators disposed in the processing pathway between the input and the output, configured to produce a plurality of crosswise plunge cuts into a strip of flexible material, wherein the strip of flexible material as a radial curvature memory in a first direction, and has a length, a width, a thickness, a top surface and a bottom surface received at the input; and
one or more benders disposed in the processing pathway configured to bend the perforated strip of flexible material in a first curvature, wherein the first curvature produces a convex shape on the first surface, wherein the bending is along a longitudinal direction of the strip of flexible material, and wherein a force applied to the strip to achieve the bending is sufficient to break some of the flexible material contributing to the radial curvature memory;
wherein the one or more perforators and one or more benders are configured to process tread strips harvested from tires.

18. The machine as set forth in claim 17 wherein the one or more perforators and one or more benders are configured to perforate and bend a second surface surface and an opposite curvature to the first curvature, respectively.

19. The machine as set forth in claim 17 wherein the perforating is performed by at least a pair of perforating barrels of blades disposed on opposite sides of the flexible strip of material, thereby compressing and perforating the strip of material between the pair of perforating barrels of blades to perform perforating on two opposite sides in a single stage.

20. The machine as set forth in claim 17 wherein the one or more perforators comprise blades.

21. The machine as set forth in claim 17 wherein the one or more perforaters and one or more benders comprise a larger diameter perforating barrel of blades and a set of smaller diameter perforating barrel of blades disposed around at least a part of a periphery of the larger diameter perforating barrel of blade, defining a space therebetween for receiving the strip of flexible material, configured to perforate and bend simultaneously.
